(19) United States
(12) Patent Application Publication
(10) Pub. No.: US 2015/0293971 A1
(43) Pub. Date: Oct. 15, 2015

(54) DISTRIBUTED QUERIES OVER GEOMETRIC OBJECTS

(71) Applicant: SPACECURVE, INC., Seattle, WA (US)

(72) Inventors: Han-Martin Will, Seattle, WA (US); Matthew Clark McCline, Seattle, WA (US)

(73) Assignee: SPACECURVE, INC., Seattle, WA (US)

(21) Appl. No.: 14/250,311

(22) Filed: Apr. 10, 2014

(51) Int. Cl. G06F 17/30; G06T 19/20; G06T 17/10

(52) U.S. Cl. CPC G06F 17/30466; G06T 17/10; G06T 19/20; G06F 17/30625; G06F 17/30914; G06T 2207/30181; G06T 2210/21; G06T 2219/2004

(57) ABSTRACT

In various embodiments, Methods, systems, computer-readable storage media, and apparatuses are described for determining interactions between geometric objects stored on distributed computing nodes. Nodes may be configured to perform a join operation in response to a query. The worker nodes may perform a source stage where source geometric objects are identified and sent to other worker nodes. The worker nodes may perform a target stage a set of target geometric objects is identified and a join operation performed on the received source and target geometric objects. The worker nodes may also perform a join operation that is based on storage of geometric objects in a storage sieve tree structure (“SST”). A space-filling curve may be used to map levels of the SST to a one-dimensional interval. The join operation may be performed only on objects whose mapped portions of the interval overlap. Other embodiments, may be described and claimed.

### BACKGROUND

An increasing number of computing applications, existing both online and offline, perform computations using geographic data. Such applications may include, for example, mapping applications, GPS applications, surveying applications, as well as other applications. As part of their computations, such applications may need to determine interactions between geometric objects. For example, a surveying application may need to determine at what points two parcels of land border each other. In another example, a mapping application may need to determine where a road shape intersects with a shape defining a city or town. While the need to perform such determinations is common, such determinations can be complex. Additionally, interactions may need to be determined for multiple objects. When these objects are distributed over multiple storage locations, determination of interactions may be particularly complex.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 is a diagram illustrating an example arrangement of distributed computer nodes for determining interactions between geometric objects, in accordance with various embodiments.

FIG. 2 is a diagram illustrating example components of front and worker nodes used for, determining interactions between geometric objects, in accordance with various embodiments.

FIG. 3 is a diagram illustrating an example structure of sieve tree used for storing geometric objects, in accordance with various embodiments.

FIG. 4 is a diagram illustrating an example storage of a geometric object in a sieve tree, in accordance with various embodiments.

FIG. 5 is a diagram illustrating an example distribution of sieve storage tree cells across multiple worker nodes, in accordance with various embodiments.

FIG. 6 is a diagram illustrating example prefix assignments to cells of a sieve tree, in accordance with various embodiments.

FIG. 7 is a diagram illustrating example space-tilling curves for a sieve tree, in accordance with various embodiments.

FIG. 8 illustrates an example high-level process for determining interactions between geometric objects, in accordance with various embodiments.

FIG. 9 illustrates an example process for storing geometric objects, in accordance with various embodiments.

FIG. 10 illustrates an example process for performing a distributed query determination, in accordance with various embodiments.

FIG. 11 is a diagram illustrating example communications between stages performed during performance of a distributed query determination, in accordance with various embodiments.

FIG. 12 illustrates a process for processing a query plan, in accordance with various embodiments.

FIG. 13 is a diagram illustrating example information flows for a source stage of a worker node, in accordance with various embodiments.

FIG. 14 illustrates a process for performing a source stage of a worker node, in accordance with various embodiments.

FIG. 15 is a diagram illustrating example information flows for a target stage of a worker node, in accordance with various embodiments.

FIG. 16 illustrates a process for performing a target stage of a worker node, in accordance with various embodiments.

FIG. 17 is a diagram illustrating an example performance of a join operation over sequences of source objects and target objects, in accordance with various embodiments.

FIG. 18 illustrates a process for performing a join over sequences of source objects and target Objects, in accordance with various embodiments.

FIG. 19 is a diagram illustrating example information flows for a merge stage of a worker node, in accordance with various embodiments.

FIG. 20 illustrates an example computing environment suitable for practicing various aspects of the present disclosure, in accordance with various embodiments.

FIG. 21 illustrates an example storage medium with instructions configured to enable an apparatus to practice various aspects of the present disclosure, in accordance with various embodiments.

### BACKGROUND

Methods, systems, computer-readable storage media, and apparatuses are described for determining interactions between geometric objects stored on distributed computing nodes. In various embodiments, a geometric object interaction system may include various nodes, such as, for example, client nodes, front nodes, and worker nodes, which may be configured to determine interactions between geometric objects stored in association with the nodes. In various embodiments, a front node may be configured to create a query plan upon receipt of a query from a client node. The front node may forward the query plan to one or more worker nodes, which may themselves be configured to retrieve geometric objects and to determine interactions between them.

In particular, worker nodes may be configured to perform a join operation in response to the query where geometric objects from a source collection are compared to geometric objects from a target collection to determine which pairs of geometric objects satisfy a predicate specified in the query. In various embodiments, the worker nodes may be configured to perform a source stage where source geometric objects that are associated with the worker nodes are identified and sent to worker nodes associated with target geometric objects. The worker nodes may also be configured to perform a target stage where, after receiving a set of source objects, the worker node identifies a set of target geometric objects that are associated with the worker node and performs a join operation on the received source geometric objects and target geometric objects to identify pairs of source and target objects that satisfy a predicate. The worker nodes may also be configured to perform a merge stage where identified pairs of source and target geometric objects received from multiple other worker nodes may be merged into a single set of identified pairs of objects, which may in turn be provided as a response to the query in various embodiments, by distributing the performance of the join operation over multiple worker nodes, the techniques described herein may provide for efficient performance of interaction determination with lower overhead and less process blocking than may be performed by other techniques.

In various embodiments, the worker nodes may also be configured to perform a join operation on source and target geometric objects that is based on storage of geometric objects in a storage sieve tree structure(“SST”). In various embodiments, the SST may map a space into multiple levels of cells, such that cells at each level may store geometric objects at successively smaller levels of granularity. In various embodiments, a space-filling curve may be used to map each level to a one-dimensional interval (such as, for example, [0,1]) such that, for a geometric object that is associated with a set of cells, the geometric object may be associated with a portion (or sub-interval) of the one-dimensional interval. Subsequently, when the join operation is performed, it may be performed only on source geometric objects and target geometric objects whose mapped portions of the interval overlap. By reducing the number of geometric objects who are compared during the join operation, the workload on individual worker nodes may be reduced.

In the following detailed description, reference is made to the accompanying drawings which form a part hereof wherein like numerals designate like parts throughout, an which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A.), (B), (C), (A and B), (A and C), (B and C), or (A, B and G). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

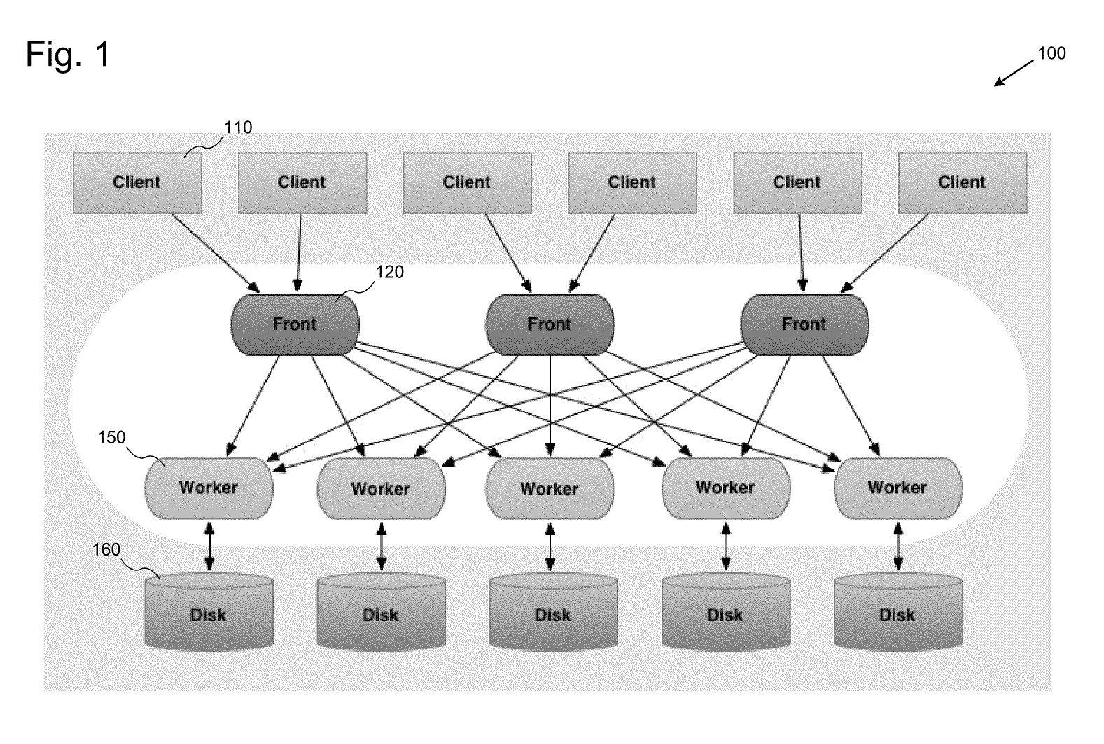

Referring now to FIG. 1, a diagram illustrating an example arrangement 100 of distributed computer nodes for determining interactions between geometric objects is illustrated in accordance with various embodiments. In various embodiments, one or more parts of the arrangement 100 may constitute a system for performing determination of interactions between geometric objects. In various embodiments, each of the illustrated nodes may include one or more computing systems as described herein. In various embodiments, when more than one computer system is included in a particular node, the computer systems may be interconnected, such as using a direct physical connection, or through a wired or wireless network. In various embodiments, the individual nodes of the arrangement 100 may include, as illustrated, client nodes 110, front nodes 120, and/or worker nodes 150. In various embodiments, these nodes may be interconnected, such as through one or more wired and/or wireless networks. In various embodiments, one or more of the client nodes 110, front nodes 120, and/or worker nodes 150 may be merged into one or more computer systems that perform operations of multiple nodes described herein.

In various embodiments, as illustrated in FIG. 1, the arrangement 100 may include one or more client nodes 110. In various embodiments, a client node 100 may include one or more computers from which queries relating to interactions between geometric objects may be requested. Additionally, in various embodiments, the results of the query may be returned to the client nodes 110.

In various embodiments, the queries may be requested as database queries, and in particular as requests for performance of join operations. In various embodiments, as may be understood, requests for performance of join operations may include identification of a collection of source geometric objects as well as a collection of target geometric objects, as well as a predicate. In various embodiments, as may be understood, if we then have a collection of source geometric objects S and another collection of target geometric objects 7′, the result of a join operation may be defined as a collection of geometric objects obtained by pairing selected objects of the first with the second selection according to a predicate P:

S [symbol] ^{P}T={(s,t)∈S×T:P(s,t)=true}

In various embodiments, such as in geospatial database management systems, geometric join operations, including join operations with predicates involving geometric objects, may lay the foundation for fusing geometric and geographic information layers. For example, geometric joins may allow the correlation of GPS-tagged information from mobile devices with geocoded reference information describing roads and buildings. In various embodiments, predicates may be utilized that that allow for expression of particular geometric relations between pairs of geometric objects. Examples of such relations include:
Intersection: This predicate may be satisfied when two objects may have a non-empty intersection or overlap each other. In some embodiments, an intersection predicate may be satisfiable even when source and target collections not necessarily distinct.
Containment: This predicate may be satisfied when one object is fully contained inside another one,
Touching: This predicate may be satisfied when two objects have boundaries with a non-empty intersection, while their interiors remain disjoint.

Returning to FIG. 1 in various embodiments, the arrangement 100 may include one or more front nodes 120. In various embodiments, a front node 120 may include one or more computer systems configured to receive a query from a client node 110 to mediate distributed determination of a query result across a set of worker nodes 150. In various embodiments, front node 100 may be configured to generate a query plan for performance by one or more worker nodes 100. As may be noticed, in some embodiments, a client node 110 may communicate with a single front node 120 to request performance of a query by the front node 120. However, in various embodiments, a front node 120 may communicate with multiple worker nodes 150 in order to facilitate determination of a query result as distributed across the multiple worker nodes 150.

As illustrated, in various embodiments, the arrangement 100 may include one or more worker nodes 150. In various embodiments the worker may include on or more computer systems configured access retrieval geometric object data, and to perform determination of geometric object interactions, such as by performing join operations on retrieved geometric objects. In various embodiments, the one or more geometric objects utilized by a worker node 150 may be found on an associated disk 160. In various embodiments, despite the term, the disk 160 may include various hardware and/or software for storing data for geometric objects and maybe located locally to its associated worker node 150, or may be located remotely to its associated worker node 150. Additionally, while in FIG. 1 only one disk 160 is illustrated in association with each worker node 150, in various embodiments multiple disks 160 (or other storage configurations) may be associated with each worker node 150.

In various embodiments, a worker node 150 may be configured to perform various operations for determination of a query result by utilizing one or more geometric objects stored on its associated disk 150. For example, in various embodiments, a worker node 150 may be configured to identify one or more source geometric objects on its associated disk 160 as part of performance of a query plan received from a front node 120. The worker node 150 may also be configured to identify other worker nodes that are believed to have access to related target geometric objects and to send sets of source geometric Objects to these other worker nodes. Thus, likewise, in various embodiments, a worker node 150 may be configured to identify one or more target geometric objects stored on its associated disk 160. The worker node may be configured to subsequently perform one or more join operations between received source geometric objects and target geometric objects and to output pairs of geometric objects that satisfy a one or more predicates. In various embodiments, a worker node 150 may be configured to receive multiple sets of these pairs from other worker nodes 150 and to merge them together into a query result. That worker node 150 may be configured to return the result to a front node 120 for use in responding to a query from a client node 110.

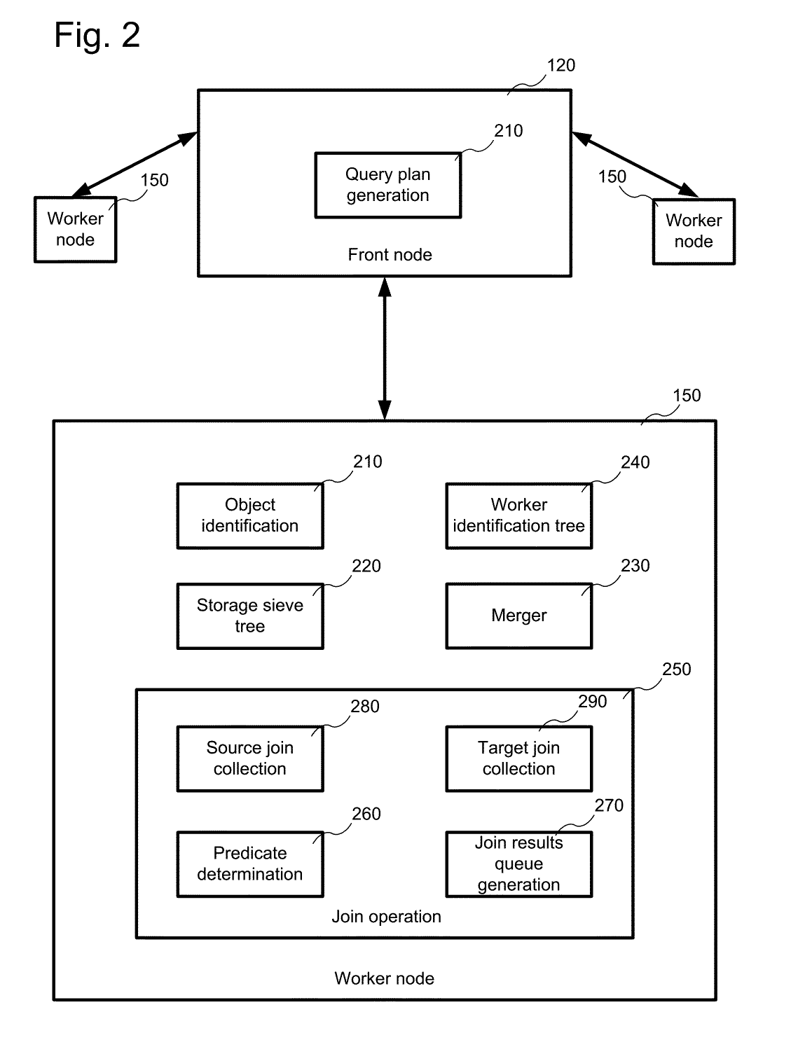

Referring now to FIG. 2, example components of front and worker nodes used for determining interactions between geometric objects are illustrated, in accordance with various embodiments. It may be noted that, while particular modules and data structures are illustrated in FIG. 2, in various embodiments, various modules and/or data structures may be merged, split into further entities, and/or omitted entirely. Further, while FIG. 2 illustrates one particular separation between a front node 120 and a worker node 150, in other embodiments, two or more front nodes 120 and/or worker nodes 150 may be merged and operations of the nodes may be combined.

In various embodiments, a front node 120 may be in communication with one or more worker nodes 150 (as illustrated by the multiple communication arrows connecting to the front node 120. In various embodiments, the front node 120 may include a query plan generation module 210 which may be configured to receive a query from a client node 110 and to generate a query plan for performance by one or more worker nodes 150. In various embodiments, a query plan may include a directed graph composed from physical query operators, which may be interconnected and distributed across a network of computers forming the arrangement 100. Each operator, such as a front node 120 or worker node 150 may take zero or more inputs from other operators located upstream in the directed graph, and may generates one or more outputs that are routed to either other nodes downstream in the graph, or that are connected to the client node 110 issuing the query. In some embodiments, there may be at most one operator that generates output that is directly sent to the client node 110. In various embodiments, a query plan generated by the query plan generation module 210 may include information from the received query itself, such as, but not limited to: identifications of collections of source geometric objects, identifications of collections of target geometric objects, and/or identifications of one or more predicates to be used to perform join operation determinations between source and target geometric objects. Examples of particular query operators include, but are not limited to: scanning of one or more data partitions that are located on a particular node, filtering a query stream based on a specific selection criteria, converting an unsorted stream of input objects into a sorted one, performing a sorted merge of one or more input streams, and so forth. In various embodiments, the query plan may also include indications of one or more worker nodes 150 which may be believed by the front node to have access to one or more source and/or target geometric objects. In various embodiments, the query plan generation module 210 of the front node 120 may be configured to send the query plan to the identified one or more front nodes 150. In some embodiments, only those front nodes that are identified as having access to source geometric objects may receive the query plan. Particular examples of generation of query plans are described below.

In various embodiments, a worker node 150 may include an object identification module 210 (“OI 210”). In various embodiments, the (“OI 210”) may be configured to identify geometric objects that may be used by the worker node for performance of a query plan, For example, for a worker node 150 that is performing a source stage (as described herein), the OI 210 may be configured to identify one or more source geometric objects that are accessible to the worker node 150, such as by being stored on an associated disk 150. Similarly, for a worker node 150 that is performing a target stage (as described herein), the OI 210 may be configured to identify one or more target geometric objects that are accessible to the worker node 150.

In various embodiments, the worker node 150 may also include a sieve tree 220 (“ST 220”), which may include a data structure used to store one or more geometric objects with reference to a particular space in which the geometric objects may be found. In various embodiments, the ST 220 may be configured to directly store geometric objects. In other embodiments, the ST 220 may be configured to store metadata associated with geometric objects, which may themselves be stored outside of the ST 220 (or even outside of the worker node 150), such as on a disk 160, as well as identifying information allowing the geometric objects to be retrieved from the storage. In various embodiments, the worker node 150 may include multiple ST 220s to cover multiple spaces.

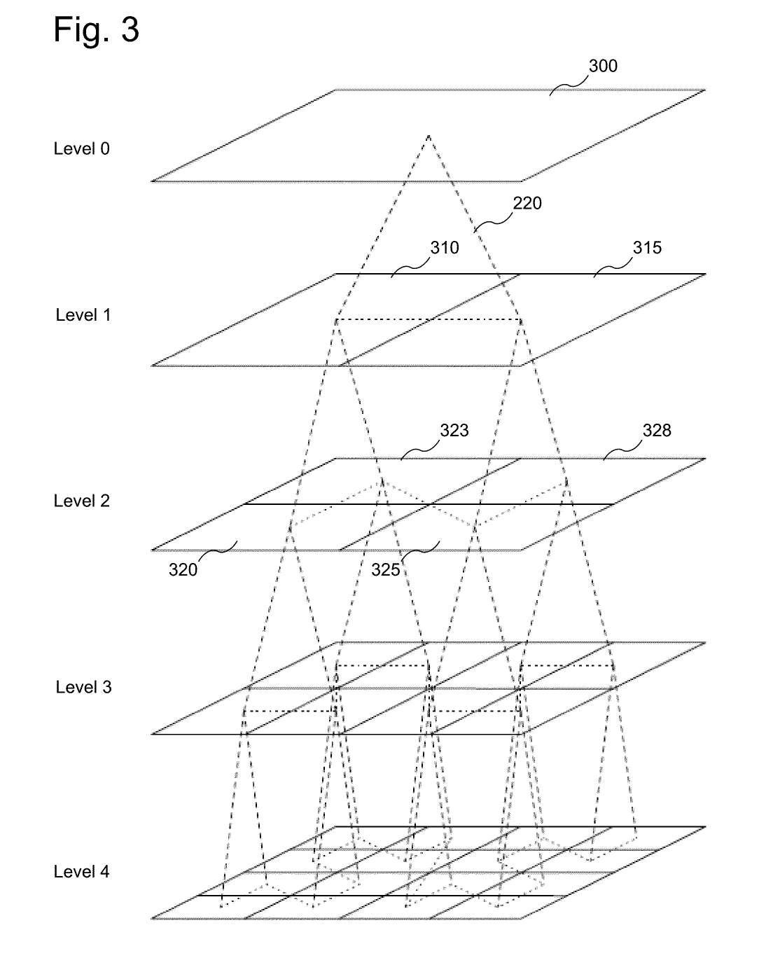

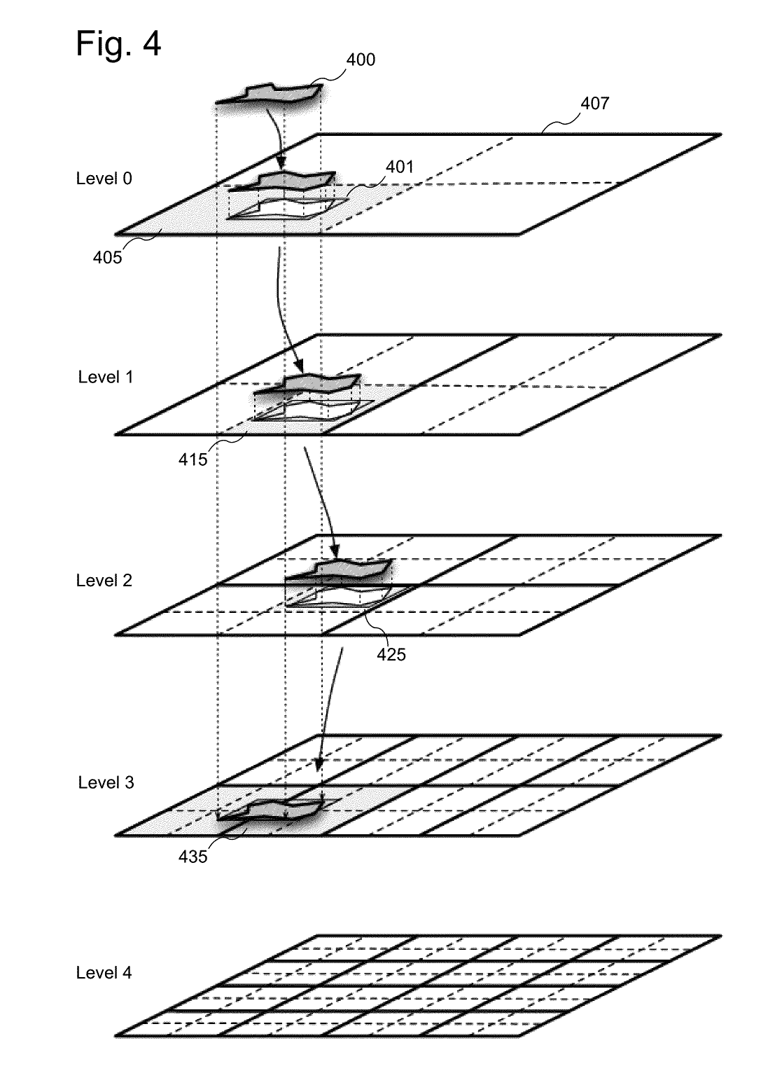

FIGS. 3-7 illustrate various aspects of the ST 220, as welt as its use in storing and ordering geometric objects for interaction determination. Referring now to FIG. 3, an example structure of sieve tree 300 used for storing geometric objects is illustrated in accordance with various embodiments. It may be noted that, while FIGS. 3 and 4 describe the use of sieve trees at a high level, additional information about use of sieve trees to store geometric objects may be found in U.S. Pat. No. 7,734, 714, issued Jun. 8, 2010, and which is hereby incorporated by reference in its entirety.

As illustrated in FIG. 3, in various embodiments a sieve tree may be constructed to represent a successive refinement of a space where geometric objects may be located. Each tree node of the ST 220 may represent a cell of the space it represents at a particular level of granularity. For example, in various embodiments, the ST 220 may be constructed according to the following operations:

1. The total space may be represented by the root node of the tree at level 0 (cell 300).

2. To build the children at level 1, the total space may be split into two equal parts along a first dimension of the underlying space. A child node of the root node may be created for each of these cells (cells 310 and 315) and a lower child node (for cell 310) and upper child node (for cell 315) may be identified.

3. The generation of each level may be continued iteratively: In order to construct the tree nodes at level 2, the cells associated with each tree node at level 1 may be taken and split it in equal parts along a second dimension. Each of the new cells may be represented by a child node of the node at level 1 representing the cell from which it was created. Again, a lower and upper cell may be distinguished. Thus, cells 320 and 323 may be represented by child nodes of the node representing cell 310, and cells 325 and 328 may be represented by child nodes of the node representing cell 315.

4. This splitting procedure may be repeated for successive levels. This may result in a binary tree structure with the property that each node will represent a cell having half the area of the cell associated with its parent, and at each level the union of all nodes covers the total space.

As discussed above, a geometric object may be stored at a particular level of the ST 220. In various embodiments, this storage may be done with reference to the particular size of the geometric object, such that smaller objects may be stored lower on the tree, in essence pouring objects into a cascade of sieves with finer and finer mesh sizes (hence the name “sieve tree” used herein). Referring now to FIG. 4, an example storage of a geometric object in a sieve tree is illustrated in accordance with various embodiments. For a given geometric Object that is contained in the space organized within the Sieve Tree, a level to store the tree at may be determined as follows.

First, an axis-aligned bounding box 401 (“AABB 401”) may be drawn around the geometric object 400. Next, a sieving process may begin with an initial level of 0, which corresponds to the root level of the ST 220. In order to determine if the object should be moved to a level higher than level 0 the size of the AABB 401 may be compared against the size of a cell 405 that is obtained by cutting the root cell 407 in half along each dimension. If the AABB is smaller than the test cell, the level under consideration may be increased to 1. The process may then be repeated at the next level. Specifically, in order to determine if the object that is currently considered for a level of i should be moved to a level of i+1, a test cell may be computed by cutting a cell at level i in half along each dimension, and determining if the AABB is smaller than this test cell. Following this process, test cells 415, 425 and 435 are all considered in turn. Eventually, the AABB can no longer be moved to a higher level at level 3, where it is larger than test cell 435. This final level is the sieve depth associated with the object 400. In various embodiments, the ST 220 does not have infinitely many levels, and in some embodiments, individual sub trees of the ST 220 may not need to have the same depth.

In various embodiments, an ST 220 may include one or more tests that identify cells represented by the SST 220 based on a given geometric objects. In the first, termed “Find Affected” herein, the SST 220 may be given the AABB of a geometric object to be inserted into the ST 220 and the SST 220 may identify cells represented in the ST 220 that need to be modified in order to provide for the insertion. In various embodiments, these identified cells are the cells that the sieving processing described above identifies. In a second test, termed “Find Intersected” herein, the SST 220 may be given the AABB of a geometric object and may identify cells represented in the tree that have a non-empty intersection with the AABB. Because multiple cells on multiple levels may intersect the AABB (such, as, for example, test cells 405, 415, and 425 discussed above) many cells may be identified by operation of the Find Intersected test for a given geometric object. In various embodiments, these tests may be used by the worker node to perform various techniques described herein.

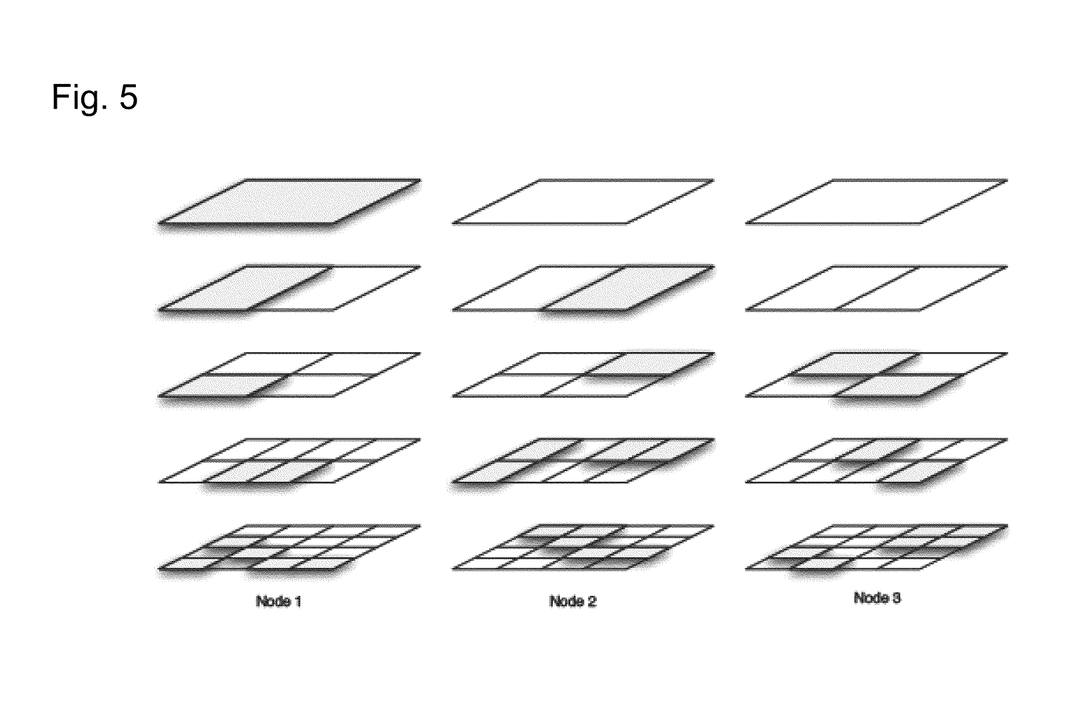

In various embodiments, as discussed herein, a worker node 150 may not store, or have access to, ever geometric object that may be found in a space. In particular, in some embodiments, the ST 220 may store information for only a subset of cells for which a space may be divided into. In some such embodiments, ST 220s of other worker nodes 150 may store geometric objects for other cells, and the union of the cells over the various ST 220s of the worker nodes 150 may make up a complete set of cells to store geometric objects for a given space. In some embodiments, these cells may be disjoint across various ST 220s. An example may be found in FIG. 5, where an example distribution of sieve storage tree cells across multiple nodes is illustrated in accordance with various embodiments. In the example of FIG. 5, cells for four levels of an ST 220 are distributed across three nodes. The ST 220 of node 1, the example, represents the root cell for level 0, along with one cell for level 1, one cell for level 2, two cells for level 3, and five cells for level 4. Likewise, nodes 2 and 3 represent cells that are not represented by the ST 220 of node 1. As may be seen in the example of FIG. 5, each node's set of represented cells is disjoint from that of any other node. Alternatively, however, in some embodiments, two or more ST 220s may represent Objects from a same cell; however, such an arrangement may not be desirable in all embodiments because it may require additional communication and/or join operation performance than if nodes store geometric objects of disjoint sets.

In various embodiments, cells represented at a particular level of an ST 220 may be ordered by use of a space-filling curve. In various embodiments, the use of a space-filling curve may provide for a mapping from a level of the ST 220 to a one-dimensional interval such as, for example, [0,1]. In various embodiments, the use of such a mapping may provide a method by which geometric objects stored in an ST 220 may be quickly compared to each other to determine if they fall within the same cells by virtue of whether their mapped portions of the interval overlap. In such embodiments, actual comparison of geometric objects may be reduced to only those whose mappings overlap, reducing overall computational requirements for query determination.

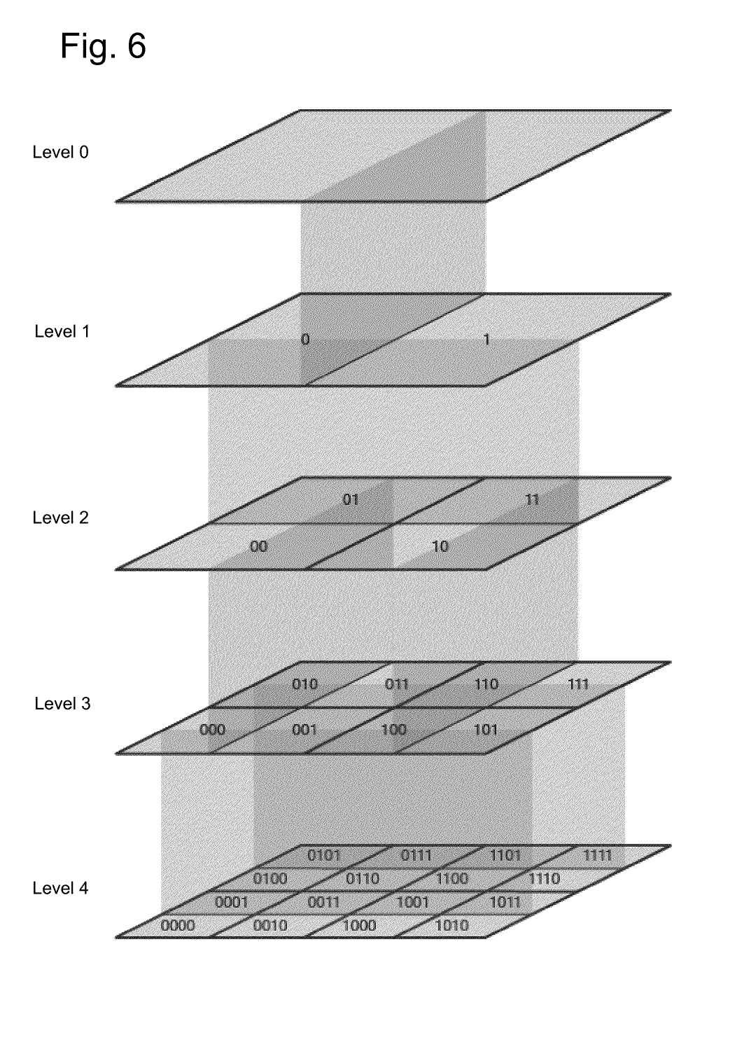

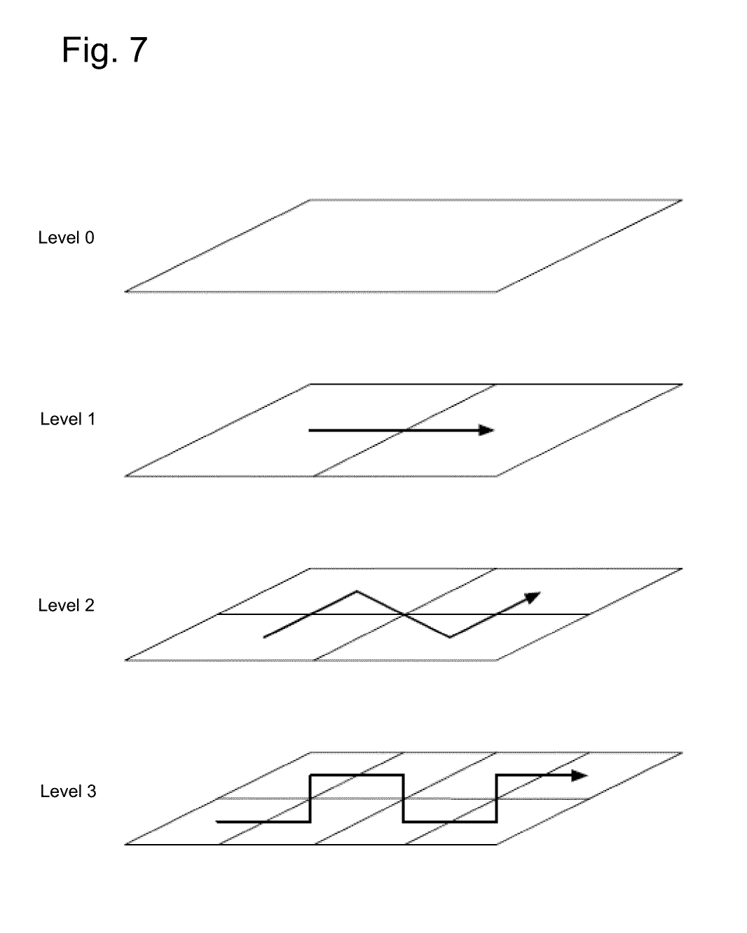

FIGS. 6 and 7 illustrate various examples of space-filling curves. Referring now to FIG. 6, a diagram illustrating example prefix assignments to cells of an ST 220 is illustrated in accordance with various embodiments. In various embodiments, the assignments of these prefixes may define a space-filling curve for a level. As illustrated in the example of FIG. 6, each cell of the ST 220 may be labeled with a binary prefix as follows. First, the root cell may be labeled with empty prefix (e.g., no prefix). Next, any cell obtained by splitting a parent cell may be associated with the concatenation of the parent's labels and 0, if the cell is represented by the lower child node of the parent node, and with the concatenation of the parent's label and 1, if it is represented by the upper child node of the parent node. In various embodiments, “lower” and “upper” may be understood as a spatial arrangement along the dimension in which the parent cell was split. As this process iterates throughout the ST 220, each cell on the n-th level of the ST 220 may be associated with a binary number with n digits, as illustrated in FIG. 6.

If the cells on each level are connected in increasing order of their labels, a curve associated with that level may be created which induces a linear order among all cells of the level. Referring now to FIG. 7, a diagram illustrating example space-filling curves for a sieve tree is illustrated in accordance with various embodiments. As FIG. 7 shows, for each of levels 0-3, the space-filling curve follows the ordering of the prefixes illustrated in FIG. 6. Additionally, the prefixes obtained on different levels can be mapped into a common one-dimensional interval, such as, for example [0,1], by using the values as prefix of a conceptually infinite binary fraction. That is, each cell with a given prefix p₁p₂p₃ . . . pₙ may be taken to represent a sub interval of [0,1] that is defined by [p₁p₂p₃ pₙ00, p₁p₂p₃ . . . pₙ11]. It may be understood that the union of each of these subintervals at each level may complete the one-dimensional interval [0,1], thus providing a mapping between the two-dimensional cells of each level and the one-dimensional interval [0,1] As mentioned herein, this mapping may be used to facilitate efficient performance of join operations between geometric objects.

Returning now to FIG. 2, the worker node 150 may include additional entities to facilitate the geometric object interactions described herein. For example, in various embodiments, the worker node may include a worker identification tree 240 (“WT 240”). In various embodiments, the WT 240 may include a tree that is identical in structure to the ST 220, but which, for each cell represented in the ST 220, stores identification of worker nodes 150 that store geometric objects for that cell. In various embodiments, multiple worker nodes 150 may include copies of the WT 240 so that each may send source geometric objects to other worker nodes during to facilitate distributed determination of geometric object interactions, as described herein. In various embodiments, the worker node 150 may also include merger module 230 which may be configured to receive queues of pairs of geometric objects (or pairs of indications of geometric objects) from other multiple worker nodes 150 and to merge these into a single queues of pairs of geometric objects. In various embodiments, the merger module 230 may receive these queues in an ordered form (such as ordered according to a space-filling curve as described above) and to output a set of pairs of geometric objects according to the orders of the received sets. In various embodiments, the merger module 230 may be configured to provide the merged set to a front node 120 as a query result, which may then be passed on to a client node 110.

In various embodiments, the worker node 150 may also include a join operation module 250 (“JO 250”), which may be configured to perform one or more join operations on geometric objects stored on the worker node 150 or on other worker nodes 150. In various embodiments, the JO 250 may include a source join collection 280 and a target join collection 290. In various embodiments, the source join collection 280 may include one or more source geometric objects which may be received from other worker nodes 150 in order for the worker node 150 to perform a join operation. In various embodiments, the target join collection 290 may include one or more target geometric objects 290 which may be stored by the worker node 150, such as on an associated disk 160, and used by the JO 250 to perform a join operation. In various embodiments, the JO 250 may perform the join operation using a predicate determination module 260, which may be configured to receive an indication of a predicate for a join operation and to iterate through the source join collection 280 and target join collection 290 to determine pairs of geometric objects which satisfy the predicate. The JO 250 may also include a join results queue generation module 270, which may combine the resulting identified pairs of geometric objects into a queue for output and subsequent merger into a query result (such as by the merger module of another worker node 150. Particular examples of operation of the JO 250 are described below.

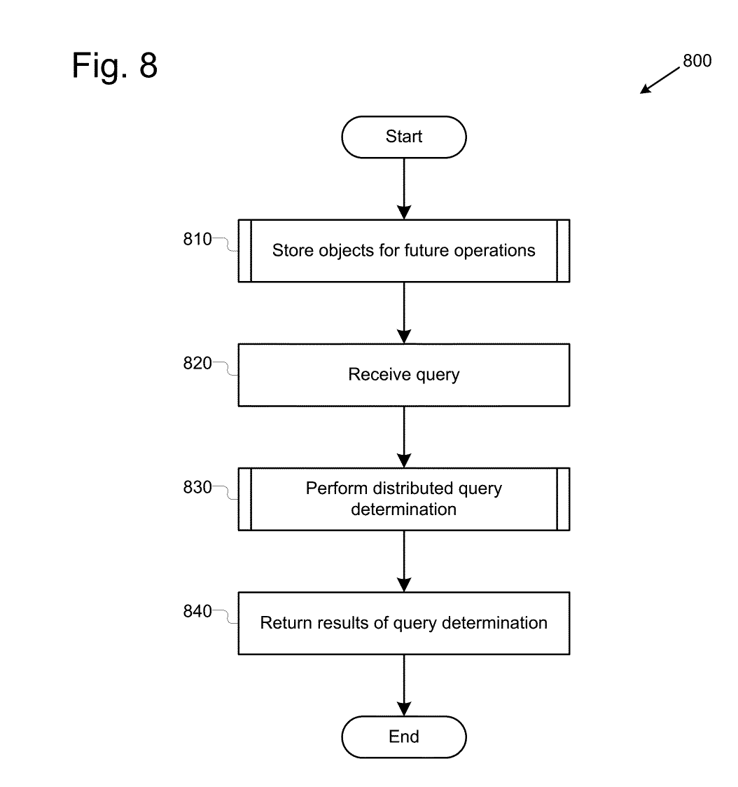

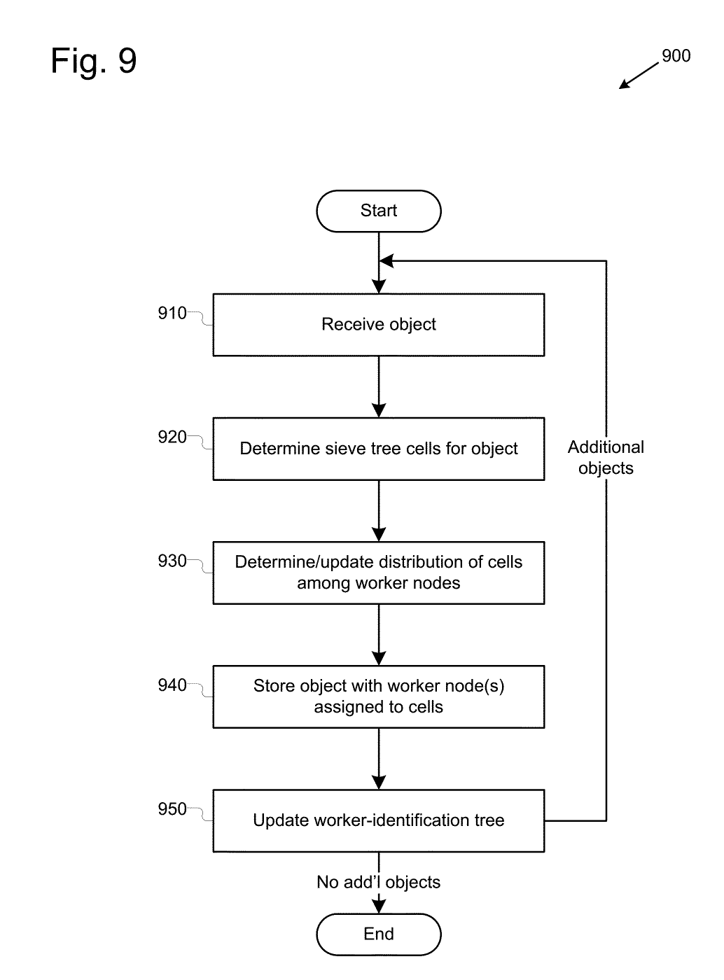

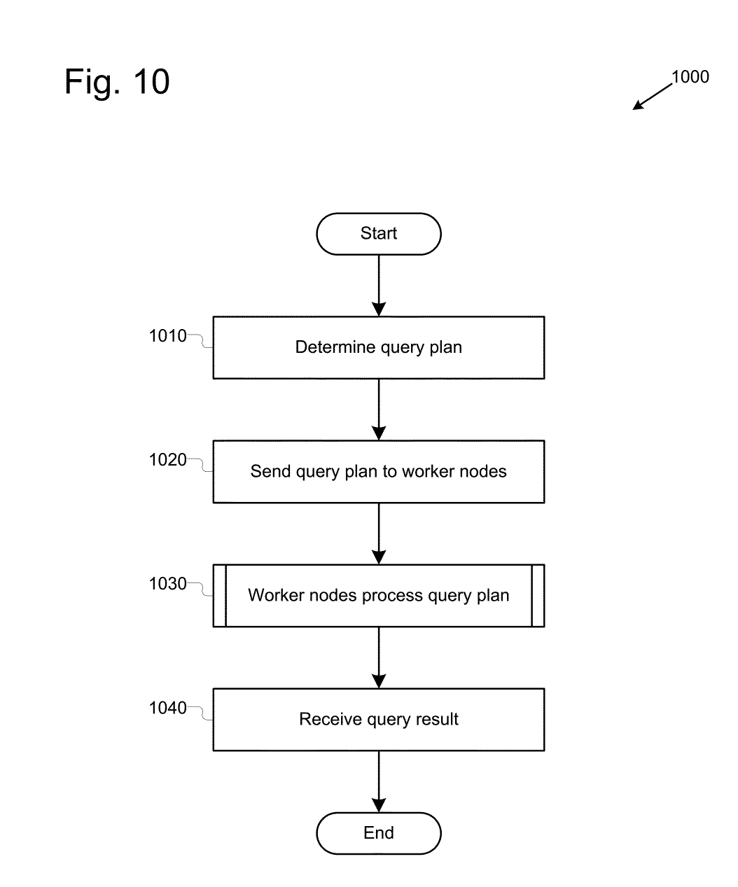

Referring now to FIG. 8, an example high-level process 800 for determining interactions between geometric objects is illustrated in accordance with various embodiments. While particular operations are illustrated in FIG. 8, it may be recognized that, in various embodiments, one or more operations may be combined into fewer operations, split into additional operations, reordered, or omitted entirely. The process may begin at operation 810, where one or more worker nodes 150 may store geometric Objects for future operations. Particular examples of operation 810 are described below with reference to process 900 of FIG. 9. Next, at operation 820, a front node may 120 receive a query from a client node 110. In various embodiments, the query may include one or more of: identification of a source collection of geometric objects, a target collection of geometric objects, and/or a predicate to be used to determine a join operation between the two collections. In various embodiments, the query received may also include one or more indications of spaces over which the query should be determined. Next, at operation 830, the front node 120 that received the query, as welt as various worker nodes 150, may perform a distributed query determination. Particular examples of operation 830 are described below with reference to process 1000 of FIG. 10. Next, at operation 84, the front node 120 may return the query results to the client node 110 that submitted the query. The process may then end.

Referring now to FIG. 9, an example process 900 for storing geometric objects is illustrated in accordance with various embodiments. While particular operations are illustrated in FIG. 9, it may be recognized that, in various embodiments, one or more operations may be combined into fewer operations, split into additional operations, reordered, or omitted entirely. Process 900 may include one or more embodiments of operation 810 of FIG. 8. The process may begin at operation 910, where a geometric object may be received by a worker node 150 for storage. Next, at operation 920, the worker node may determine which at which cells of the ST 220 the geometric object may be stored. In various embodiments, the worker node 150 may perform a process similar to that described above with reference to FIG. 4. It may be noted that, for a given geometric object, the object may be stored at multiple cells.

Next, at operation 930, the worker node may determine or update its knowledge of which cells are distributed amongst the ST 220s of the various worker nodes 150. In various embodiments, if no distribution has previously been performed, such as if only one worker node 150 has been storing objects to that point, the worker node 150 may determine a distribution for the first time. In other embodiments, if cells have been distributed, the worker node 150 may determine if any changes have been made, or if new cells need to be assigned to worker nodes 150 (such as if the received object is at a lower level than had previously been seen). Next, at operation 940, the geometric object may be stored to one or more worker nodes 150 that have been assigned to the cells determined for the geometric object. In various embodiments, one or more worker nodes 150 may transmit the geometric object between each other in order to provide the geometric object for storage at the various worker nodes 150. Next, the WT 240 may be updated at each worker node 150 if necessary so that each worker node 150 may have knowledge of which worker nodes are storing objects for which cells. After operation 950, if additional objects need to be stored, the process may repeat at operation 910. If, not the process may end.

FIG. 10 illustrates an example process for performing a distributed query determination, in accordance with various embodiments. While particular operations are illustrated in FIG. 10, it may be recognized that, in various embodiments, one or more operations may be combined into fewer operations, split into additional operations, reordered, or omitted entirely. Process 1000 may include one or more embodiments of operation 830 of FIG. 8. The process may begin at operation 1010, where the front node 120 that received the query from the client node 110 may determine a query plan. In various embodiments, the front node 120 may determine the query plan to include indications of the source collection of geometric objects, target collection of geometric objects, and/or the predicate received in the received query. In other embodiments, the query plan may include an indication of which worker nodes 150 are believed to have access to the source geometric objects and/or target geometric objects. The query plan may also indicate which worker node 150 is to act to merge the various queues of pairs of geometric objects that are generated by the worker nodes 150 during join operation performance. The query plan may also indicate which front node 120 has generated the plan so that the resulting merged queue can be returned to the front node 120 for responding to the client node 110 that sent the query.

In some embodiments, the front node 120 may determine a query plan by analyzing syntax and semantics of the query expression provided by the client node 110. In various embodiments, metadata that describes various database tables may be analyzed in order to verify that the query expression maps to an underlying database schema used by the arrangement 100. The front node 120 may also convert declarative specification of the query language into an imperative specification of executable instructions that can be executed by the system as part of the query plan. In various embodiments, the front node 120 may also use metadata describing which parts (partitions) of a logical table are stored on which physical machine in order transform the instructions to arrive at a physical query plan where specific worker nodes 150 are assigned. In various embodiments, the front node 120 may optimizing for data locality and minimization of network traffic during the generation of such a plan. In various embodiments, other aspects of generation of a query plan may be understood by those of ordinary skill in the art.

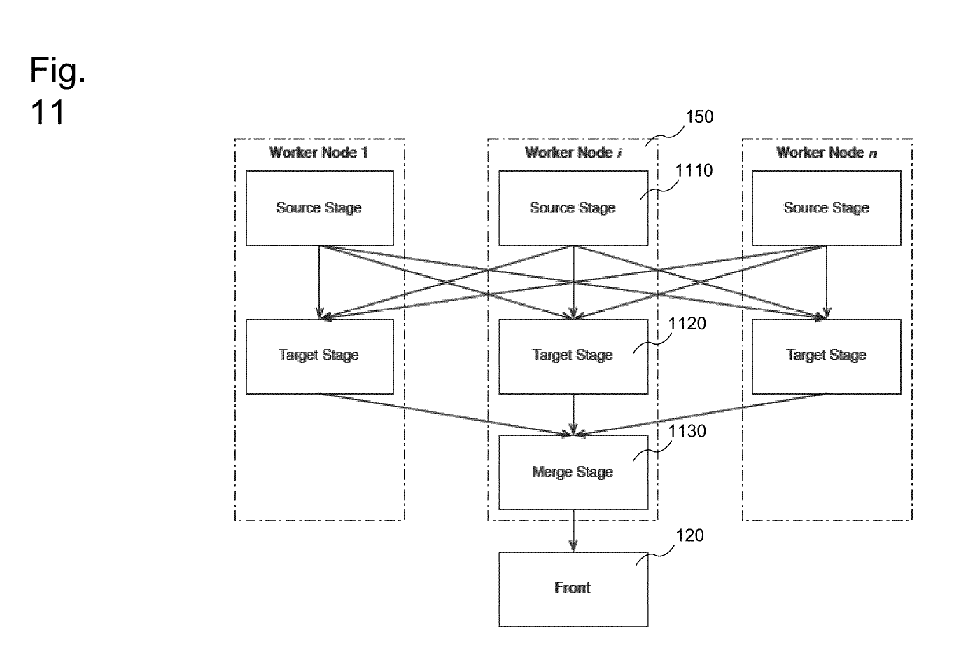

Next, at operation 1020, the front node may send the query plan to relevant worker nodes 150 that are to perform the query plan. Next, at operation 1030, the worker nodes 150 may process the query plan. Particular embodiments of operation 1030 are described below with reference to FIGS. 11-19. Next, at operation 1040, the front node 120 may receive a queue of pairs of geometric objects produced by performance of the query plan at operation 1030. That queue may later be returned as a query result. The process may then end.

As mentioned above, operation 1030 of FIG. 10 may be performed, in various embodiments, according to the examples of FIGS. 11-19. Referring now to FIG. 11, example communications between stages performed during performance of a distributed query determination is illustrated in accordance with various embodiments. In particular, it may be noted that, during performance of a query plan, one or more workers may perform one or more of a source stage 1110, a target state 1120, and/or a merge stage 1130. In various embodiments, during performance of the source stage 1110, a worker node 150 may identify one or more source geometric objects that are stored by, or otherwise accessible to, the worker node 150 and send these source geometric objects to one or more other worker nodes (and/or maintain them internally, such as in the example of worker node i in FIG. 11) for performance of a target stage 1120. The other worker nodes 150 to which the source geometric objects are sent may be identified by the worker node 150 during the source stage 1110 by using the WT 240, as mentioned above.

In various embodiments, at the target stage 1120, a worker node 150 may receive one or more source geometric objects from other worker nodes 150. The worker node may also identify one or more target geometric objects that are stored by, or otherwise accessible to, the worker node 150. The worker node 150 may also perform a join operation on the received source geometric objects and the identified target geometric objects to generate a queue of pairs of geometric objects that satisfy a predicate. The resulting queue of pairs may then be sent to another worker node 150 (or maintained internally, such as in the example of worker node i in FIG. 11) for merger into a query result. Then at the merge stage 1130, a worker node may merge one or more received queues of pairs of geometric objects into a query result. This result may be returned to a front node 120.

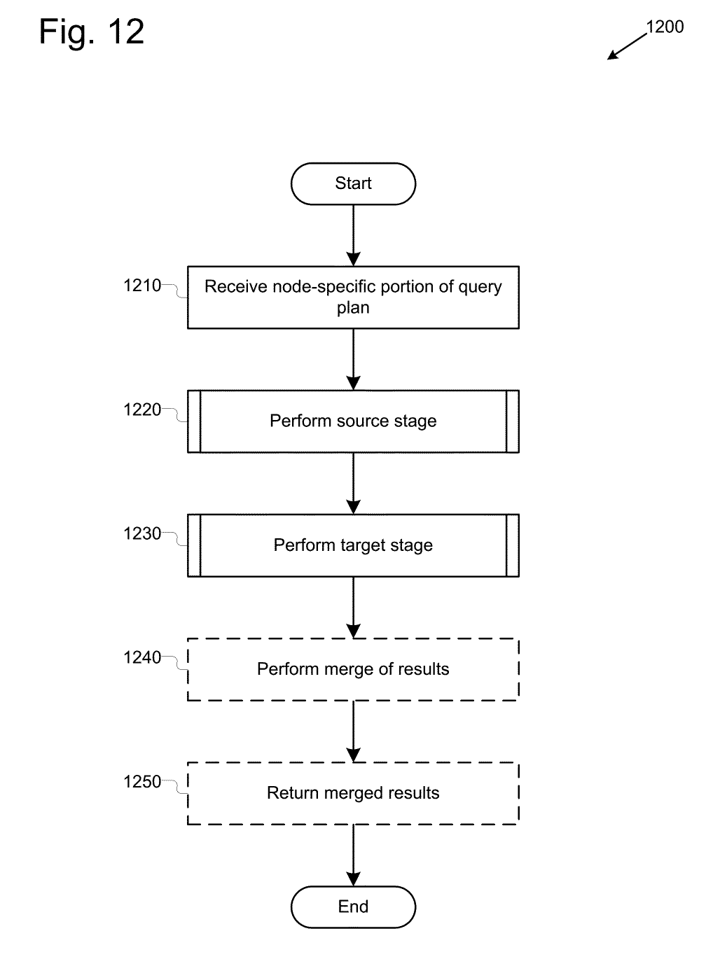

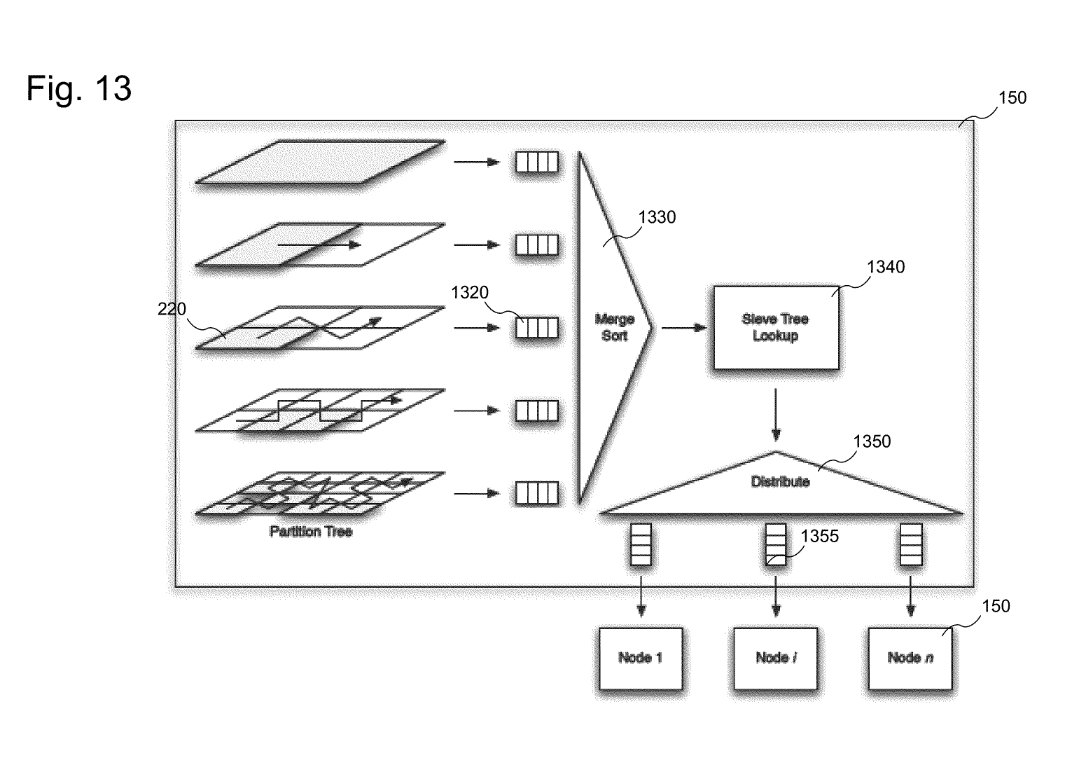

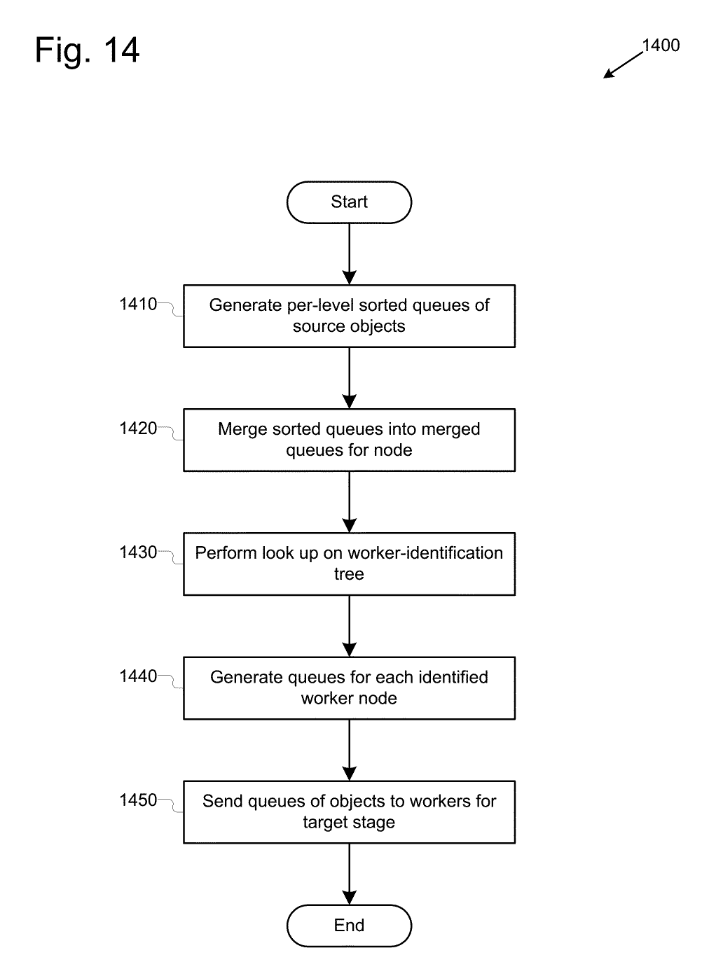

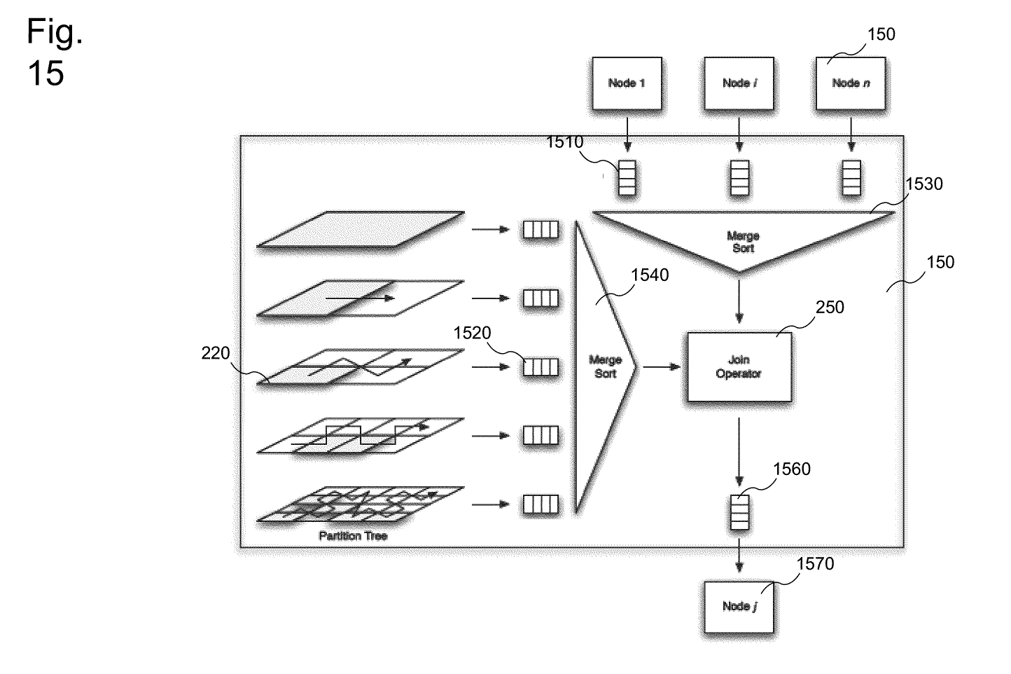

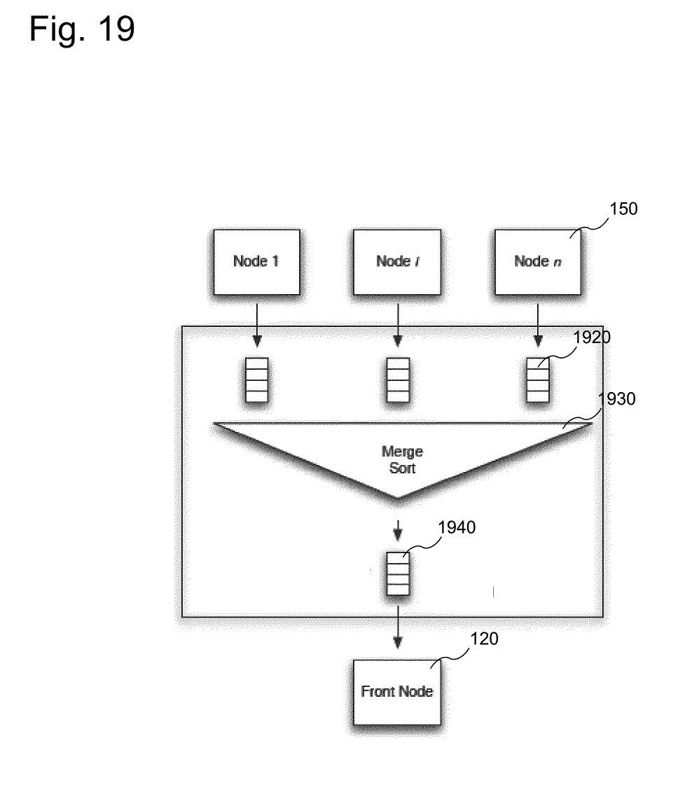

Referring now to FIG. 12, a process 1200 for processing a query plan is illustrated in accordance with various embodiments. While particular operations are illustrated in FIG. 12, it may be recognized that, in various embodiments, one or more operations may be combined into fewer operations, split into additional operations, reordered, or omitted entirely. Process 1200 may include one or more embodiments of operation 1030 of FIG. 10. The process may begin at operation 1210, where the worker node 150 may receive the query plan. In some embodiments, at operation 1210 the worker node 150 may receive only a portion of the query plan that is specific to the worker node 150. Next, at operation 1220, the worker node 150 may perform the source stage. Various embodiments of the source stage may be described below with reference to FIGS. 13 and 14. Next, at operation 1230, the worker node 150 may perform the target stage. Various embodiments of the source stage may be described below with reference to FIGS. 15-18. Next, at operation 1240, the worker node 150 may optionally perform the merge the resulting queues of pairs of geometric objects. In FIG. 12 the merge stage is illustrated with a dotted line to illustrate that it is performed by fewer worker nodes 150 than other stages; however, it may be recognized that, similarly, not every worker node may perform the source stage and the target stage as well. Next, at operation 1250, the worker node 1250 may optionally send the resulting merged queue to the requesting front node as a query result. Examples of merger are described below with reference to FIG. 19. After operation 1250, the process may end.

Referring now to FIG. 13, example information flows for a source stage of a worker node are illustrated in accordance with various embodiments. As illustrated at a worker node 150, an ST 220 may be consulted, such as by the object identification module 210, to determine one or more source geometric objects that may be used by the JO 250 during the target stage. In various embodiments, the object identification module may output queues 1320 of source geometric objects at each level in order along the space-filling curve. This ordering may facilitate later performance of the JO 250. In various embodiments, in order to avoid temporary storage for sorting source geometric objects of the source collection, the object identification module 210 may traverse each level of the ST 220 along the space-filing curve. In some embodiments, the object identification module 210 may skip over cells that are not present on at the particular worker node 150 that is performing the source stage. In various embodiments, if the geometric objects were sorted upon insertion to the ST 220, they may be directly emitted in order as the queues 1320. Next, these queues 1320 may be merged via a merge sort 1330 into a combined ordered queue. In some embodiments, this merger may requires only a buffer for the next item from each input stream, since the queues are already in order, providing efficiencies at each worker node 150.

After merger to generate a combined queue, the worker node may perform a sieve tree lookup at 1340 to utilize the WT 240 to identify those worker nodes that may have access to target objects. In some embodiments, this lookup may be accomplished by using a Find Intersected lookup against the WT 240. After determining the set of worker nodes 150 to which the source objects need to be sent, they are distributed at 1350 into send queues 1355, which are then sent to peer worker nodes 150.

Referring now to FIG. 14, a process 1400 for performing a source stage of a worker node is illustrated in accordance with various embodiments. While particular operations are illustrated in FIG. 14, it may be recognized that, in various embodiments, one or more operations may be combined into fewer operations, split into additional operations, reordered, or omitted entirely. Process 1400 may include one or more embodiments of operation 1220 of FIG. 12. The process may begin at operation 1410, where the object identification module 210 may identify per-level sorted queues of source geometric objects, as described above. Next, at operation 1420, the worker node 150 may merge these queues into a merged queue for the node. Next, at operation 1430, the worker node 150 may perform the lookup using the WT 240 to identify other worker nodes to which the source geometric objects should be sent. At operation 1440, queues may be generated for each of the identified worker nodes, and these queues may be sent to the worker nodes for the target stage at operation 1450. The process may then end.

Referring now to FIG. 15, example information flows for a target stage of a worker node 150 are illustrated in accordance with various embodiments. As illustrated, during the target stage, As illustrated at a worker node 150, an ST 220 may be consulted, such as by the object identification module 210, to determine one or more target geometric objects that may be used by the JO 250 during subsequent performance of a join operation. In various embodiments, the object identification module may output queues 1520 of target geometric objects at each level in order along the space-filling curve. These queues may be output in order along the space-filling curve as described above with reference to the source stage. Next, these queues 1520 may be merged via a merge sort 1540 into a combined ordered queue. In addition, source geometric object queues 1510 may be received from one or more worker nodes 150 and may themselves be merged via a merge sort 1530 into a combined source geometric queue. These combined queues may be operated on by the JO 250 to identify a queue 1560 of pairs of geometric objects that are the result of the local join operation performed at the worker node 150. This queue 1560 may be output to another worker node 150 for merger with results from other worker nodes.

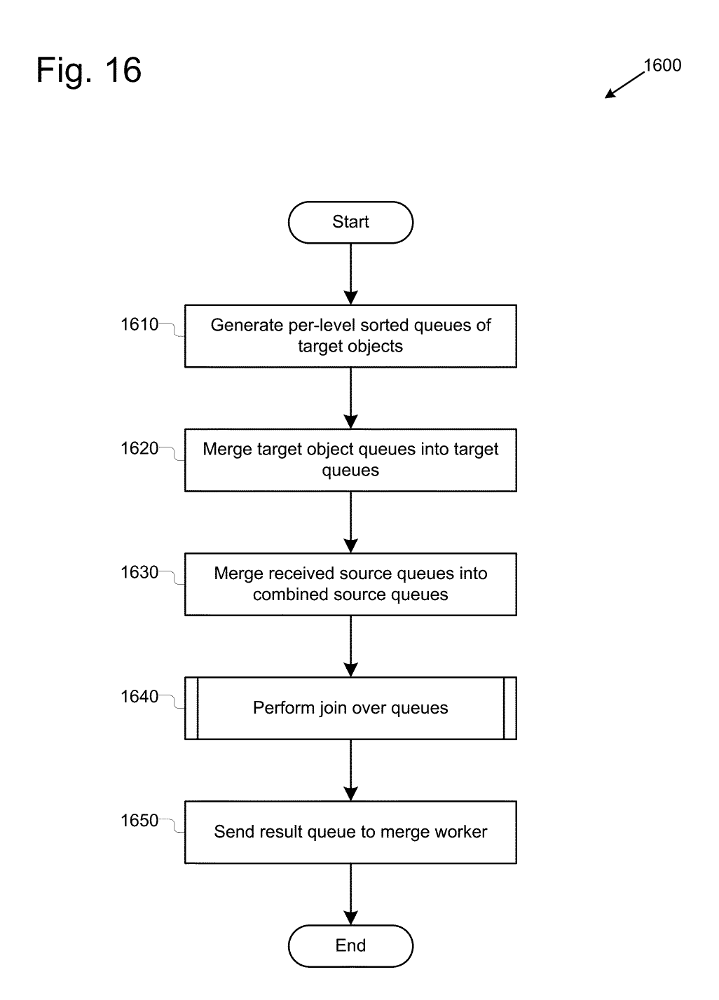

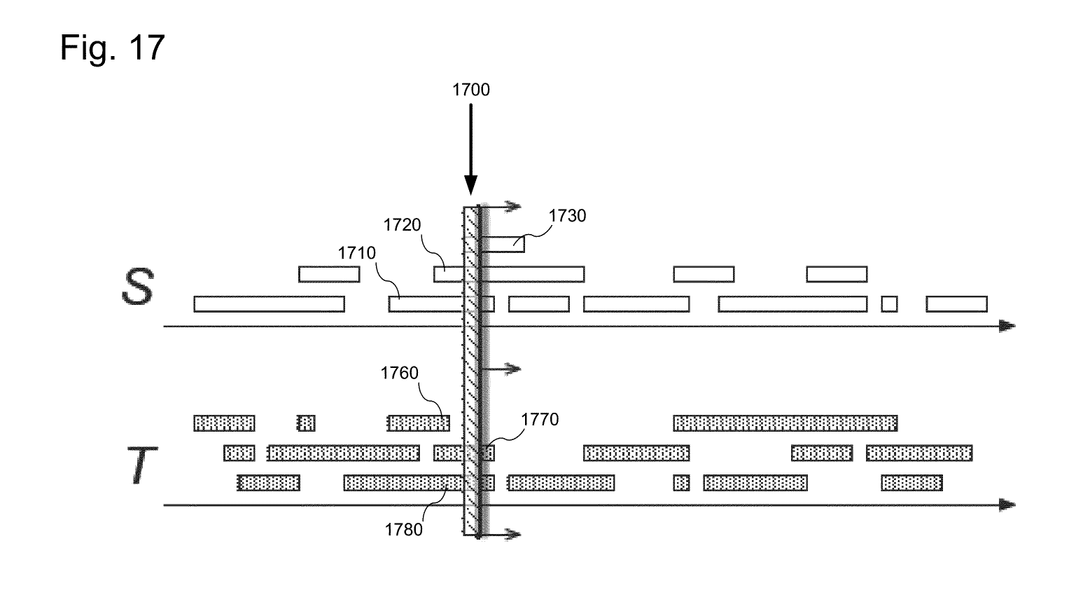

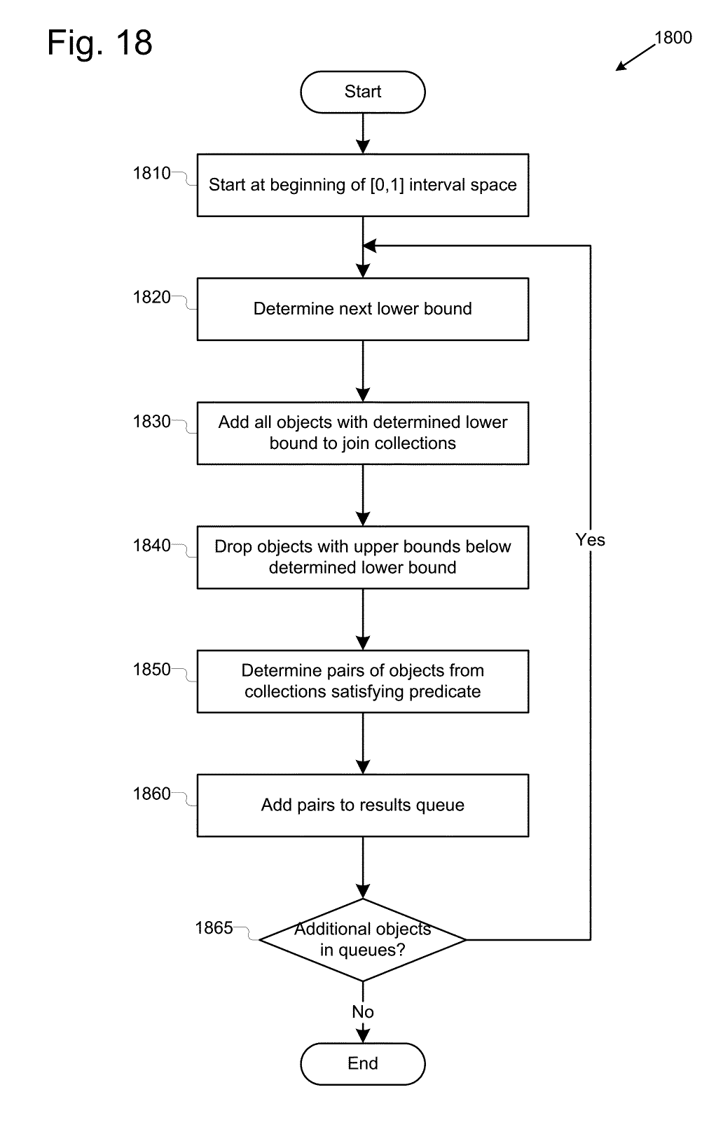

Referring now to FIG. 16, a process 1600 for performing a target stage of a worker node 150 is illustrated in accordance with various embodiments. While particular operations are illustrated in FIG. 16, it may be recognized that, in various embodiments, one or more operations may be combined into fewer operations, split into additional operations, reordered, or omitted entirely. Process 1600 may include one or more embodiments of operation 1230 of FIG. 12. The process may begin at operation 1610, where the object identification module 210 may identify per-level queues of target geometric objects. Next, at operation 1620, the worker node 150 may merge these target queues into a combined target geometric object queue. At operation 1630, the worker node 150 may merge source geometric object queues received from multiple worker nodes into a combined source geometric object queue. Next, at operation 1640, the JO 250 may perform a join operation over the combined queues. Particular embodiments of performance of the join operation are described below with reference to FIGS. 17 and 18. Next, at operation 1650, the resulting queue of pairs of geometric objects (e.g. those identified by the JO 250 as satisfying the predicate provided in the query plan) may be sent to a worker queue for merger. The process may then end.

Referring now to FIG. 17, an example performance of a join operation over sequences of source objects and target objects is illustrated in accordance with various embodiments. As illustrated in FIG. 17, in various embodiments, performance of a join operation by JO 250 may thought of as intuitively as sweeping a ruler 1700 left-to-right along the two combined queues of source and target geometric objects as they are mapped to the [0,1] interval. As the ruler 1700 is swept over the two sets of portions of the interval, the JO 250 may test for possible interactions between geometric objects by restricting these tests to only those geometric objects whose mapped portions of the interval currently intersect the ruler line. In some embodiments, this action of the JO 250 may be thought of as a state machine that goes through a transition for each unique beginning or end of a portion of the interval from either of the data collections.

In various embodiments, as mentioned above, the source geometric objects and target geometric objects used as input into the JO 50 may be sorted in ascending order according to the lower bound of each portion of the interval. In various embodiments, the ruler 1700 may be represented as a state vector tracking active intervals that need to be considered for interval intersection testing. The mapped objects to these active intervals may include geometric objects for which the mapped lower bound has been seen, and for which the mapped upper bound has not been processed yet; these objects may be tracked in the source join collection 280 and the target join collection 290 as discussed above. The operator may processes both input queues by picking the next objects with mapped lowest bound from either of its two input queues. Those objects are added to the source join collection 280 or the target join collection 290, as appropriate. At this point, intervals recorded in the state vector whose mapped upper bound is lower than the mapped lower bound of the newly added object may be removed from the state vector and their associated objects may be removed from the source join collection 280 or the target join collection 290 as appropriate.

After the source join collection 280 and the target join collection 290 are set for a state transition, the JO 250 may then checks if the newly added (for example from the source collection) objects have satisfy the received query predicate with the objects tracked for the other collection (for example from the target collection). This may be performed by the predicate determination module 260. For those pairs of geometric objects that satisfy the predicate, the pairs are recorded. The JO 250 may then proceed to the next input objects from the input queues until both queues have been processed to their end.

In the example of FIG. 17, the JO 250 has transitioned to a new state corresponding to the lower bound of the portion 1730. At this point, the object mapped to portion 1730 may be added to the source join collection 280. Likewise, the object mapped to by portion 1760, whose upper bound is lower than the current position of the ruler 1700, may be dropped from the target join collection 290. Next, the newly-added object mapping to portion 1830 may be compared by predicate determination module 260 to the objects in the target join collection mapped to by portions 1770 and 1780. If either of these objects satisfies the predicate along with the object mapped by portion 1730, the pair of objects may be output as part of the eventual query result.

Referring now to FIG. 18, a process 1800 for performing a join over sequences of source objects and target objects is illustrated in accordance with various embodiments. While particular operations are illustrated in FIG. 18, it may be recognized that, in various embodiments, one or more operations may be combined into fewer operations, split into additional operations, reordered, or omitted entirely. Process 1800 may include one or more embodiments of operation 1640 of FIG. 16. The process may begin at operation 1810, where the JO 250 may start at the beginning of the [0, 1] interval. Next, at operation 1820, the JO 250 may determine a next lower bound out of the mapped portions of the interval. Next, at operation 1830 all objects that have mapped portions that match this determined lower bound may be added the source join collection 280 or the target join collection 290, as appropriate. Next, at operation 1840, any objects may be dropped whose upper bounds of their mapped portions are lower than the previously-determined next lower bound. At operation 1850, the predicate determination module 260 may determine pairs of objects from the source join collection 280 and the target join collection 290 that satisfy the predicate received in the query plan. At operation 1860, the join results queue generation module 270 may add the determined pairs to the result queue. Next, at decision operation 1865, the JO 250 may determine if there are additional objects in the input queues. If so, the process may repeat at operation 1820. If not, the process may end.

Referring now to FIG. 19, example information flows for a merge stage of a worker node 150 are illustrated in accordance with various embodiments. The actions illustrated in FIG. 19 may correspond, in various embodiments, to operations 1240 and 1250 of FIG. 12. As illustrated, during the merge state, multiple worker nodes 150 may provide queues 1920 of pairs of geometric objects as results from their individual performance of their own JO 250. These queues may be merged via a merge sort 1930 into a query result queue 1940, which may then be sent to a front node 120. It may be recognized that while a single worker node is depicted as performing the merge here, depending on the number of worker nodes 150 in the system, merging can be done using multiple worker nodes, such as organized as a tree of worker nodes performing a merge stage.

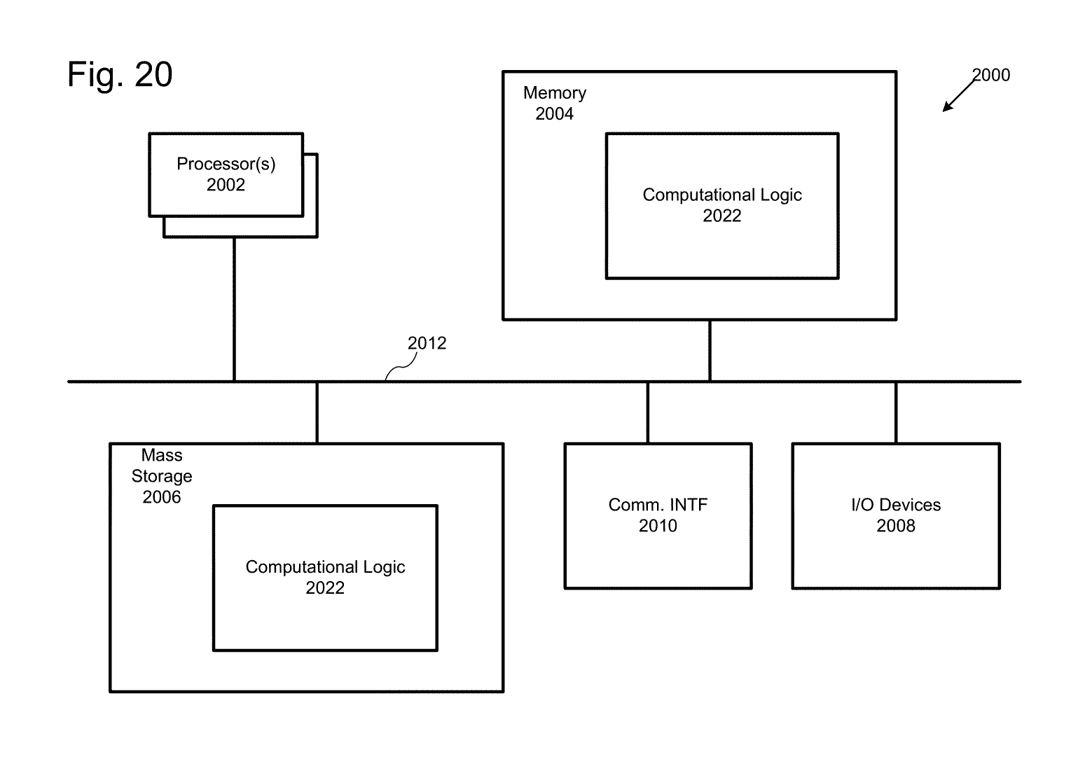

Referring now to FIG. 20, an example computer suitable for practicing various aspects of the present disclosure, including processes described herein, is illustrated in accordance with various embodiments. As shown, computer 2000 may include one or more processors or processor cores 2002, and system memory 2004. For the purpose of this application, including the claims, the terms “processor” and “processor cores” may be considered synonymous, unless the context clearly requires otherwise. Additionally, computer 2000 may include mass storage devices 2006 (such as diskette, hard drive, compact disc read only memory (“CD-ROM”) and so forth), input/output devices 2008 (such as display, keyboard, cursor control, remote control, gaming controller, image capture device, and so forth) and communication interfaces 2010 (such as network interface cards, modems, infrared receivers, radio receivers (e.g., Bluetooth), and so forth). The elements may be coupled to each other via system bus 2012, which may represent one or more buses. In the case of multiple buses, they may be bridged by one or more bus bridges (not shown).

Each of these elements may perform its conventional functions known in the art. In particular, system memory 2004 and mass storage devices 2006 may be employed to store a working copy and a permanent copy of the programming instructions implementing the operations associated with distributed geometric Object interaction determination, collectively referred to as computing logic 2022. The various elements may be implemented by assembler instructions supported by processor(s) 2002 or high-level languages, such as, for example, C, that can be compiled into such instructions.

The permanent copy of the programming instructions may be placed into permanent storage devices 2006 in the factory, or in the field, through, for example, a distribution medium (not shown), such as a compact disc (“CD”), digital versatile disc, (“UM”), or through communication interface 2010 (from a distribution server (not shown)). That is, one or more distribution media having an implementation of the agent program may be employed to distribute the agent and program various computing devices.

The number, capability and/or capacity of these elements 2010-2012 may vary. Their constitutions are otherwise known, and accordingly will not be further described.

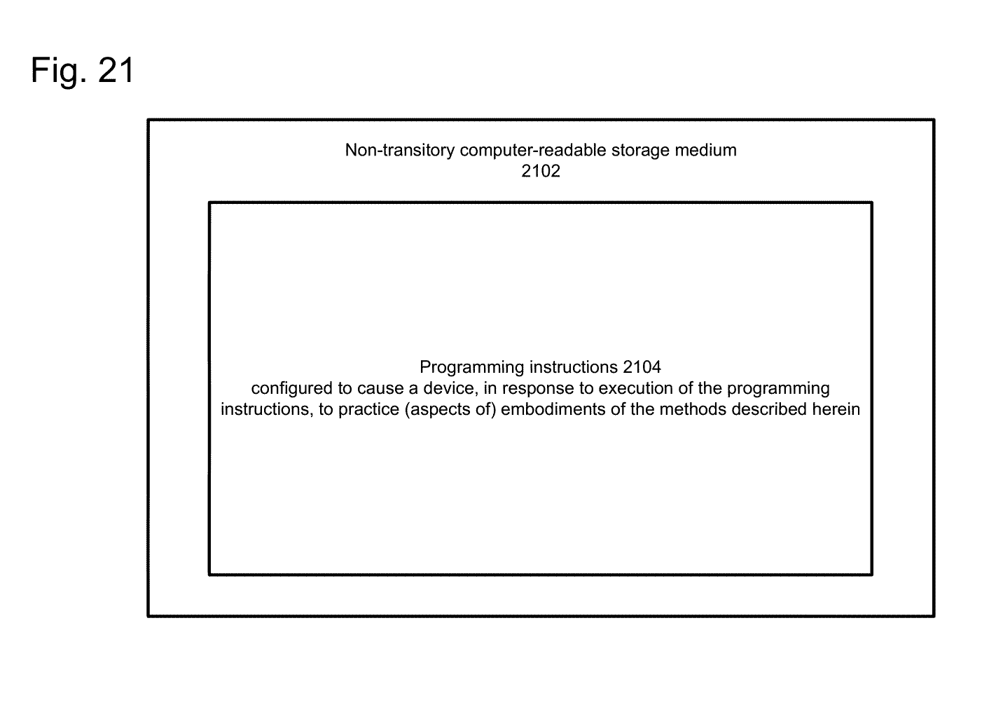

FIG. 21 illustrates an example least one non-transitory computer-readable storage medium 2102 having instructions configured to practice all or selected ones of the operations associated with distributed geometric object interaction determination, earlier described, in accordance with various embodiments. As illustrated, the at least non-transitory one computer-readable storage medium 2102 may include a number of programming instructions 2104. Programming instructions 2104 may be configured to enable a device, e.g., computer 2000, in response to execution of the programming instructions, to perform, e.g., various operations of processes described herein, but not limited to, to the various operations performed to perform distributed geometric object interaction determination. In alternate embodiments, programming instructions 2104 may be disposed on multiple non-transitory one computer-readable storage media 2102 instead.

Referring back to FIG. 20, for one embodiment, at least one of processors 2002 may be packaged together with memory having computational logic 2022 configured to practice aspects of processes described herein. For one embodiment, at least one of processors 2002 may be packaged together with memory having computational logic 2022 configured to practice aspects of processes described herein to form a System in Package (“SiP”). For one embodiment, at least one of processors 2002 may be integrated on the same die with memory having computational logic 2022 configured to practice aspects of processes described herein. For one embodiment, at least one of processors 2002 may be packaged together with memory having computational logic 2022 configured to practice aspects of processes described herein to forma System on Chip (“SoC”). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method for performing a geometric object join operation between distributed geometric objects, the method comprising:
identifying, at a first set of computing nodes, a set of source geometric objects to utilize for performance of a geometric object join operation, wherein the set of source geometric objects are locally accessible to the first set of computing nodes;
identifying, by the first set of computing nodes, a second set of computing nodes for which a set of target geometric objects are locally accessible;
sending, by the first set of computing nodes, source geometric objects out of the set of source geometric objects to computing nodes out of the second set of computing nodes;
performing, each of at the second set of computing nodes, the geometric object join operation by comparing one or more received source geometric objects to one or more locally accessible target geometric objects to identify one or more pairs of source geometric objects and target geometric objects that satisfy a predicate associated with the geometric object join operation, wherein the comparing is performed according to an ordering relationship between geometric objects that applies to objects out of both the one or more source geometric objects and the one or more target geometric objects.

2. The method of claim 1, wherein sending source geometric objects comprises, for each computing node of the first set of computing nodes, sending source geometric objects which are locally accessible to the computing node in an order according to the ordering relationship.

3. The method of claim 1, further comprising:
sending, by each of the second set of computing nodes, one or more pairs of source geometric objects and target geometric objects that satisfy the predicate to computing nodes of a third set of computing nodes; and
merging, by the third set of computing nodes, received pairs of source geometric objects and target geometric objects into a result for the geometric object join operation.

4. The method of claim 1, wherein:
the first set of computing nodes and the second set of computing nodes are configured to store geometric objects in a spatial sieve tree; and
the ordering relationship comprises an ordering relationship that orders geometric objects based at least in part on storage locations for the geometric objects in the spatial sieve tree.

5. A method for determining interactions between geometric objects comprising:
receiving, by a computing system, one or more source geometric objects from one or more other computing systems;
comparing, by the computing system, the one or more source geometric objects to one or more target geometric objects that are locally available to the computing system to identify one or more pairs of source geometric objects and target geometric objects that satisfy a predicate, wherein the comparing is performed according to an ordering relationship between geometric objects that applies to objects out of both the one or more source geometric objects and the one or more target geometric objects; and
outputting, by the computing system, the one or more pairs of source geometric objects and target geometric objects that satisfy the predicate.

6. The method of claim 5, wherein the ordering relationship comprises an ordering relationship that orders geometric objects based at least in part on their relative size.

7. The method of claim 5, wherein the ordering relationship comprises an ordering relationship that orders geometric objects based at least in part on their location in an area.

8. The method of claim 5, wherein the ordering relationship comprises an ordering relationship that orders geometric objects based at least in part on storage locations for the geometric objects in a spatial sieve tree.

9. The method of claim 8, wherein the spatial sieve tree is configured to store geometric objects of arbitrary sizes on different levels.

10. The method of claim 9, wherein the spatial sieve tree is configured to store geometric objects of different sizes on different levels.

11. The method of claim 5, wherein:
the ordering relationship comprises a mapping of the one or more source geometric objects and the one or more target geometric objects to sub-intervals of a one-dimensional interval: and
comparing comprises:
performing the mapping for each of the one or more source geometric objects and one or more target geometric objects; and
comparing only source geometric objects and target geometric objects whose associated sub-intervals overlap in the one-dimensional interval.

12. The method of claim 11, wherein performing the mapping, comprises, for a geometric object out of the one or more source geometric objects and one or more target geometric objects:
identifying a level where the object is stored in a spatial sieve tree;
identifying cells in the spatial sieve tree associated with the object;
for a space-filing curve that fills the level, identifying a portion of the space filling curve that is associated with the cells; and
mapping the portion of the space-filling curve to a sub-interval of the one-dimensional interval.

13. The method of claim 5, wherein:
the comparing and outputting are performed in response to a query identifying a source collection of geometric objects and a target collection of geometric objects;
the one or more source geometric objects are from the source collection of geometric objects;
the one or more target geometric objects are from the target collection of geometric objects; and
the ordering relationship applies to objects out of both the source collection of geometric objects and the target collection of geometric objects.

14. The method of claim 13, further comprising receiving a query plan identifying the source collection of geometric objects and the target collection of geometric objects.

15. The method of claim 14, further comprising:
identifying, by the computing system, one or more locally accessible source geometric objects from the source collection of geometric objects that are accessible to the computing system; and
sending, by the computing system, the one or more locally accessible source geometric objects to an other computing system that has also received the query plan.

16. The method of claim 15, further comprising identifying the other computing system, by the computing system, as having access to target geometric objects from the target set of geometric objects.

17. The method of claim 5, wherein geometric objects out of the locally-accessible target subset of geometric objects are stored on one or more storage devices associated with the computing device.

18. One or more computer-readable media containing instructions written thereon that, in response to being executed by a computing system, cause the computing system to determine interactions between geometric objects by causing the computing system to:
receive one or more source geometric objects from one or more other computing systems;
compare the one or more source geometric objects to one or more target geometric objects that are locally available to the computing system to identify one or more pairs of source geometric objects and target geometric objects that satisfy a predicate, wherein the comparing is performed according to an ordering relationship between geometric objects that applies to objects out of both the one or more source geometric objects and the one or more target geometric objects; and
output the one or more pairs of source geometric objects and target geometric objects that satisfy the predicate.

19. The computer-readable media of claim 18, wherein:
the ordering relationship comprises a mapping of the one or more source geometric objects and the one or more target geometric objects to sub-intervals of a one-dimensional interval; and
compare comprises:
perform the mapping for each of the one or more source geometric objects and one or more target geometric objects; and
compare only source geometric objects and target geometric Objects whose associated sub-intervals overlap in the one-dimensional interval.

20. The computer-readable media of claim 19, wherein perform the mapping, comprises, for a geometric object out of the one or more source geometric objects and one or more target geometric objects:
identify a level where the object is stored in a spatial sieve tree;
identify cells in the spatial sieve tree associated with the object;
for a space-filing curve that fills the level, identify a portion of the space tilling curve that is associated with the cells; and
map the portion of the space-filling curve to a sub-interval of the one-dimensional interval.

21. The computer-readable media of claim 18, wherein:
the compare and output are performed in response to a query identifying a source collection of geometric objects and a target collection of geometric objects;
the one or more source geometric objects are from the source collection of geometric objects;
the one or more target geometric objects are from the target collection of geometric objects; and
the ordering relationship applies to objects out of both the source collection of geometric objects and the target collection of geometric objects.

22. The computer-readable media of claim 21, wherein the instructions are further configured to cause the computing system to receive a query plan identifying the source collection of geometric objects and the target collection of geometric Objects.

23. The computer-readable media of claim 22, wherein the instructions are further configured to cause the computing system to:
identify one or more locally accessible source geometric Objects from the source collection of geometric objects that are accessible to the computing system; and
send the one or more locally accessible source geometric objects to an other computing system that has also received the query plan.

24. The computer-readable media of claim 23, wherein the instructions are further configured to cause the computing system to identify the other computing system as having access to target geometric objects from the target set of geometric objects.

25. An apparatus for determining interactions between geometric objects, the apparatus comprising:
one or more computing processors; and
logic configured to execute on the one or more computing processors to:
receive one or more source geometric objects from one or more other apparatuses;
compare the one or more source geometric objects to one or more target geometric objects that are locally available to the apparatus to identify one or more pairs of source geometric objects and target geometric objects that satisfy a predicate, wherein the comparing is performed according to an ordering relationship between geometric objects that applies to objects out of both the one or more source geometric objects and the one or more target geometric objects; and
output the one or more pairs of source geometric objects and target geometric objects that satisfy the predicate.

26. The apparatus of claim 25, wherein:
the ordering relationship comprises a mapping of the one or more source geometric objects and the one or more target geometric objects to sub-intervals of a one-dimensional interval; and
compare comprises:
perform the mapping for each of the one or more source geometric objects and one or more target geometric objects; and
compare only source geometric objects and target geometric objects whose associated sub-intervals overlap in the one-dimensional interval.

27. The apparatus of claim 26, wherein perform the mapping, comprises, for a geometric object out of the one or more source geometric objects and one or more target geometric objects:
identify a level where the object is stored in a spatial sieve tree;
identify cells in the spatial sieve tree associated with the object;
for a space-filing curve that fills the level, identify, a portion of the space filling curve that is associated with the cells; and
map the portion of the space-filling curve to a sub-interval of the one-dimensional interval.

28. The apparatus of claim 27, wherein:
the compare and output are performed in response to a query identifying a source collection of geometric objects and a target collection of geometric objects;
the one or more source geometric objects are from the source collection of geometric objects;
the one or more target geometric objects are from the target collection of geometric objects; and
the ordering relationship applies to objects out of both e source collection of geometric objects and the target collection of geometric objects.

29. The apparatus of claim 28, wherein the logic is further configured to execute on the apparatus to receive a query plan identifying the source collection of geometric objects and the target collection of geometric objects.

30. The apparatus of claim 29, wherein the logic is further configured to execute on the apparatus to:
identify one or amore locally accessible source geometric objects from the source collection of geometric objects that are accessible to the apparatus; and
send the one or more locally accessible source geometric objects to an other apparatus that has also received the query plan.

31. The apparatus of claim 30, wherein the logic is further configured to execute on the apparatus to identify the other apparatus as having access to target geometric objects from the target set of geometric objects.
